(19) United States
(12) Patent Application Publication
(10) Pub. No.: US 2018/0110241 A1
(43) Pub. Date: Apr. 26, 2018

(54) AQUEOUS KETOGENIC COMPOSITIONS

(71) Applicant: Cambrooke therapeutics, Inc., Ayer, MA (US)

(72) Inventors: Kurt Olson, Chicago, IL (US); Susan Gingrich, Hamilton, MA (US)

(73) Assignee: Cambrooke therapeutics, Inc., Ayer, MA (US)

(21) Appl. No.: 15/561,824

(22) PCT Filed: Mar. 25, 2016
(86) PCT No.: PCT/US2016/024299

§ 371 Date: Sep. 26, 2017

Related U.S. Application Data
(60) Provisional application No. 62/138,949, filed on Mar. 26, 2015.

(51) Int. Cl. A23L 2/52; A23L 33/18; A23L 29/262; A23L 33/115; A23L 33/15; A23L 33/155; A23L 33/19; A23L 33/00; A23L 29/10; A23L 3/00; A23L 33/10; A23L 33/16

(52) U.S. Cl. CPC A23L 2/52; A23L 33/18; A23L 29/262; A23L 33/115; A23L 33/15; A23L 33/155; A23V 2002/00; A23L 33/40; A23L 29/10; A23L 3/00; A23L 33/10; A23L 33/16; A23L 33/19

(57) ABSTRACT

Described herein are liquid nutritional formulas, such as liquid ketogenic formulas, useful, for example, for management of intractable epilepsy. A ketogenic diet is a high-fat, adequate-protein, low-carbohydrate diet whose consumption shifts metabolism from glycolysis (the metabolism of carbohydrates) and favors ketosis, the metabolism of fatty-acid derived ketone bodies. A ketogenic diet is useful as an alternative therapeutic option for patients with intractable epilepsy and is often the sole source of nutrition, particularly for infants and children.

### RELATED APPLICATIONS

This Application is a national stage filing under 35 U.S.C. § 371 of international (PCT) patent application number PCT/US2016/024299, filed Mar. 25, 2016 and entitled “Aqueous Ketogenic Compositions”, which claims the benefit under 35 U.S.C. § 119(e) of U.S. provisional patent application Ser. No. U.S. Ser. No. 62/138,949, filed Mar. 26, 2015 and entitled “Aqueous Ketogenic Compositions”, the entire contents of each of which are incorporated herein by reference.

### BACKGROUND

Intractable epilepsy is a disorder characterized by persistent seizures that do not respond to pharmaceutical intervention with antiepileptic drugs (AEDs). The ketogenic diet is an alternative therapeutic option for patients with intractable epilepsy. The ketogenic diet may also be useful in the dietary management of certain medical conditions, such as neurodegenerative disease (e.g., Alzheimer's disease), certain cancers (e.g., brain tumors and malignant glioblastomas) and diseases related to certain inborn errors of metabolism (e.g., glucose transporter syndrome and pyruvate dehydrogenase deficiency).

However, the ketogenic diet is strict, often unpalatable, has unpleasant side effects and patient compliance is poor, particularly in children. Furthermore, protein sources used in some ketogenic diets are incompatible with food allergies (e.g. milk or nut allergies) present in some patients. A large percentage of patients utilizing ketogenic diet therapy have co-morbidities that may require nutrition support via enteral tube feeding. Further, a large percentage of these patients may be immobile and at higher risk for reflux aspiration, GI dysmotility, and bone health challenges. Accordingly, new compositions for use in ketogenic diets are needed.

### SUMMARY

A ketogenic diet is a high-fat, adequate-protein, low-carbohydrate diet whose consumption shifts metabolism from glycolysis (the metabolism of carbohydrates) and favors ketosis, the metabolism of fatty-acid derived ketone bodies. A ketogenic diet is useful as an alternative therapeutic option for patients with intractable epilepsy and is often the sole source of nutrition, particularly for infants and children. Currently-utilized ketogenic formulas may contain protein sources that are incompatible with an individual's food allergies or sensitivities. For example, some ketogenic formulas contain whole milk proteins (e.g., casein and/or whey).

Described herein are aqueous (liquid) ketogenic compositions of low allergenicity and a potential renal acid load (PRAL) that is less than or equal to zero. Such aqueous ketogenic compositions address some of the problems associated with consumption of currently-available ketogenic compositions. In some embodiments, the aqueous ketogenic composition comprises fat, hydrolyzed protein, such as protein that is degraded enzymatically, by acid, or by alkaline treatment (protein hydrolysate), which is of low allergenicity, and carbohydrate; the ratio of fat (grams) to combined protein and net carbohydrate (grams) (grams of fat/grams of combined net carbohydrate and protein) is from 3:1 to 4:1; at least 10% of calories are from medium chain triglycerides (MCTs); and the potential renal acid load (PRAL) is less than or equal to zero. Hydrolyzed protein can be whey protein. Hydrolyzed protein comprises peptides of less than 1500 Daltons and is of low allergenicity. Alternatively, or in addition, the aqueous ketogenic composition comprises free amino acids.

The liquid ketogenic composition has a caloric density between about 0.8 kcal/mL and about 3 kcal/mL and in some embodiments, the caloric density is about 1.5 kcal per mL. In some embodiments, the liquid ketogenic composition is nutritionally complete. In some embodiments, the pH of the liquid ketogenic composition ranges between about pH 5.8 and about pH 6.8. In some embodiments, the composition has an osmolality between about 200 mOsm/kg to about 350 mOsm/kg.

Fat in the liquid ketogenic composition provides at least 86% of the calories in the composition. In some embodiments, fat provides at least 90% of the calories in the composition. In some embodiments, fat is between about 10% and about 15% of the total weight of the composition. In some embodiments, fat provides at least the recommended daily intake (RDI) of linoleic and/or alpha linolenic acid for children 1 year and older.

The composition has protein of low allergenicity. In some embodiments, protein comprises between about 60% and about 90% peptides having a molecular weight less than between about 1000 Daltons and about 1500 Daltons. In some embodiments, protein comprises at least 75%, at least 80%, or at least 85% peptides having a molecular weight less than about 1500 Daltons. In some embodiments, protein comprises at least 82% peptides having a molecular weight less than 1500 Daltons or at least 90% peptides having a molecular weight less than about 1500 Daltons. In some embodiments, protein is between about 2% and about 5% of the total weight of the composition. In some embodiments, protein is whey protein isolate, soy protein hydrolysate, and/or animal protein hydrolysate (e.g., pork protein hydrolysate). In some embodiments, protein comprises protein hydrolysate. Protein hydrolysate can be partially hydrolysated protein and/or extensively hydrolysated protein. In some embodiments, protein is free amino acids. Free amino acids may be essential amino acids, non-essential amino acids, or essential amino acids and non-essential amino acids.

Low allergenicity of such liquid ketogenic compositions is an important characteristic and is the result of the type and amount (percent of the composition) of protein used. In some embodiments, at least 80% of the protein hydrolysate is peptides having a molecular weight of less than 1500 Daltons. In some embodiments, at least 80% of the protein is peptides of molecular weight less than about 1500 Daltons. In some embodiments, at least 85% of the protein is peptides of molecular weight of less than about 1500 Daltons. Hydrolysated proteins and/or free amino acids may be easier to absorb into the gut and result in improved gastric emptying (e.g. in patients having compromised gastrointestinal function). In some embodiments, the composition comprises about 0.2 grams protein to about 0.3 grams protein per gram fat.

In some embodiments, carbohydrate is less than about 1% of the total weight of the composition. In some embodiments, carbohydrate ranges from about 1% to about 4% of the total weight of the composition. In some embodiments, carbohydrate is a gum. In some embodiments, carbohydrate comprises carboxymethyl cellulose, microcrystalline cellulose, oligosaccharides, carrageenan or some other combination of the foregoing carbohydrates. In some embodiments, the composition does not contain supplemental fiber. In some embodiments, the composition does not contain artificial or nutritive sweeteners.

In some embodiments, the emulsifier is selected from the group consisting of sodium stearoyl lactylate, lecithin, starches, gums and biopolymeric emulsifiers.

In some embodiments, the composition further comprises carnitine, selenium, or carnitine and selenium. In some embodiments, carnitine, selenium, or carnitine and selenium are supplemental (e.g., not naturally present in any other component of a formula). In some embodiments, carnitine is present at a concentration between about 2 mg to about 35 mg per 100 mL composition. In some embodiments, selenium is present at a concentration between about 8 μg (mcg) to about 30 μg (mcg) per 100 mL composition.

In some embodiments, the composition further comprises at least one antioxidant.

In some embodiments, the composition comprises at least one vitamin selected from the groups consisting of: Vitamin A, Vitamin D3, Vitamin B 1, Vitamin B12, Vitamin B2, Vitamin B6, Vitamin K2, Vitamin K1, Vitamin B3, Vitamin B5, Biotin, Folic Acid, and at least one mineral selected from the group consisting of: Calcium, Chromium, Copper, Iodine, Iron, Manganese, Magnesium, Molybdenum, Phosphorus, Choline and Zinc. In some embodiments, less than about 1% of the total weight of the composition comprises vitamins and minerals.

One embodiment of the composition is shown in the Table. In some embodiments, the composition is in a container and sterilized by retort processing.

### BRIEF DESCRIPTION OF DRAWINGS

FIG. 1 shows nutritional information for one embodiment of a ketogenic formula described herein.

FIG. 2 shows nutritional information for one embodiment of a ketogenic formula described herein.

FIG. 3 shows nutritional information for one embodiment of a ketogenic formula described herein.

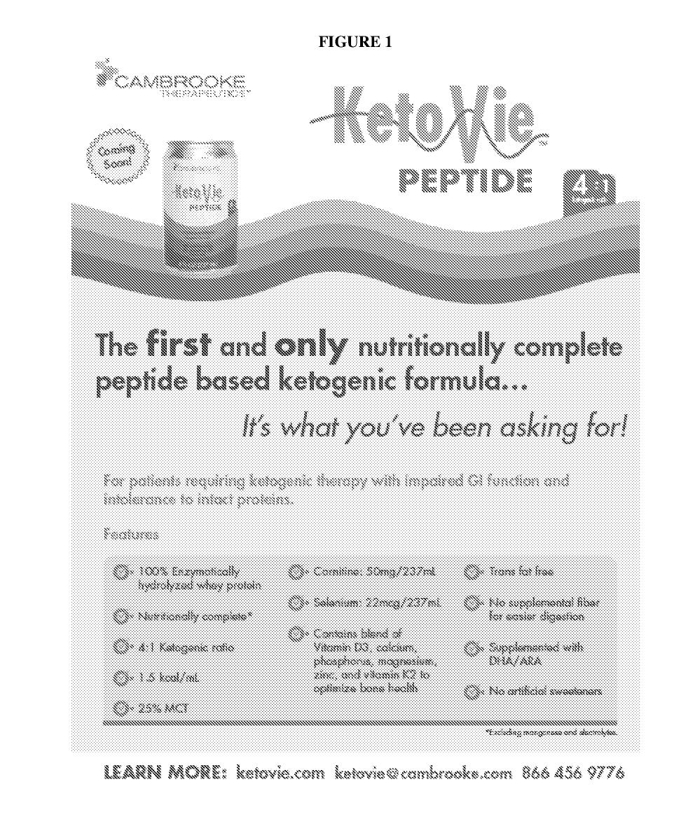

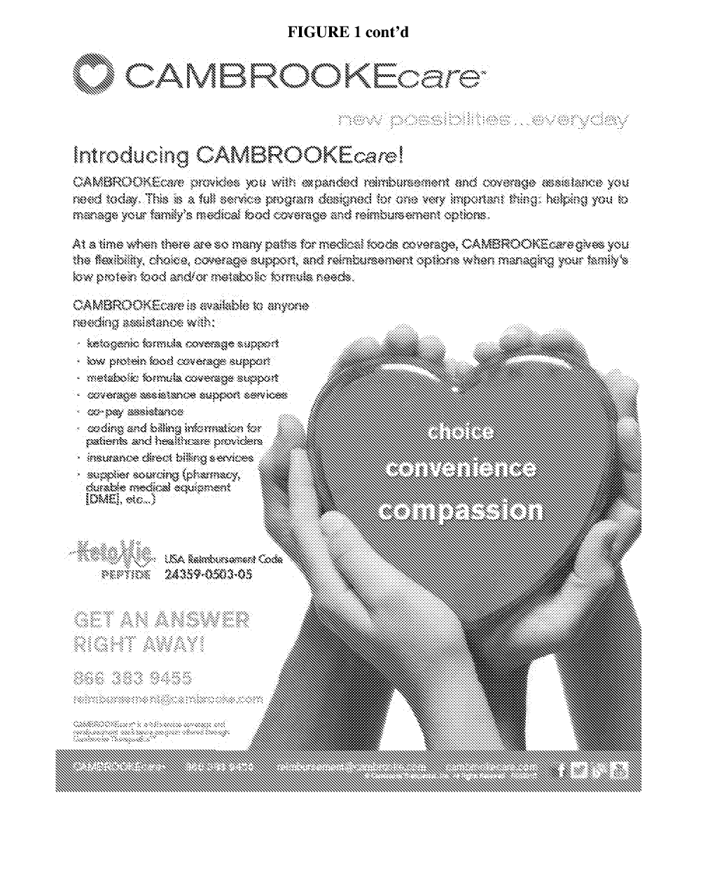

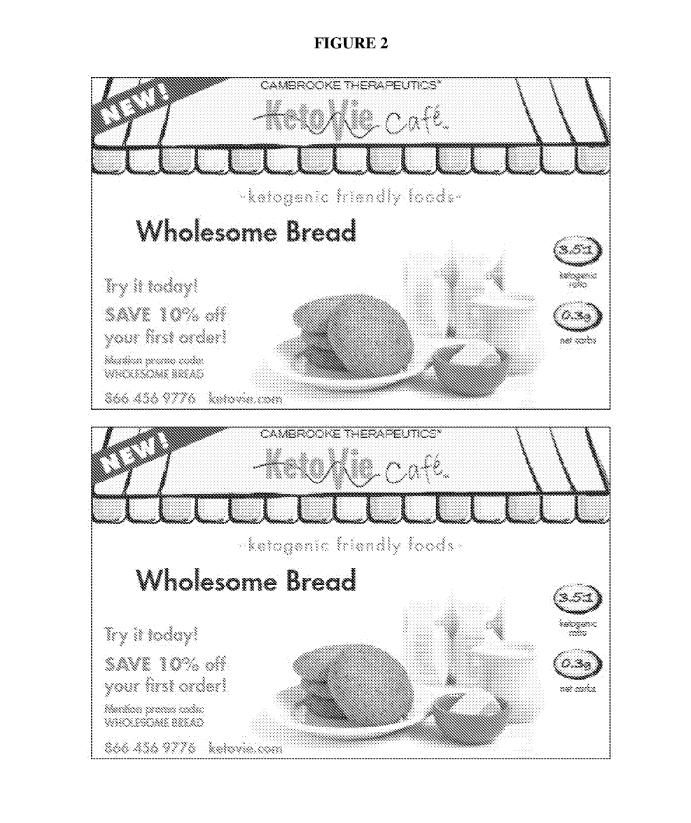

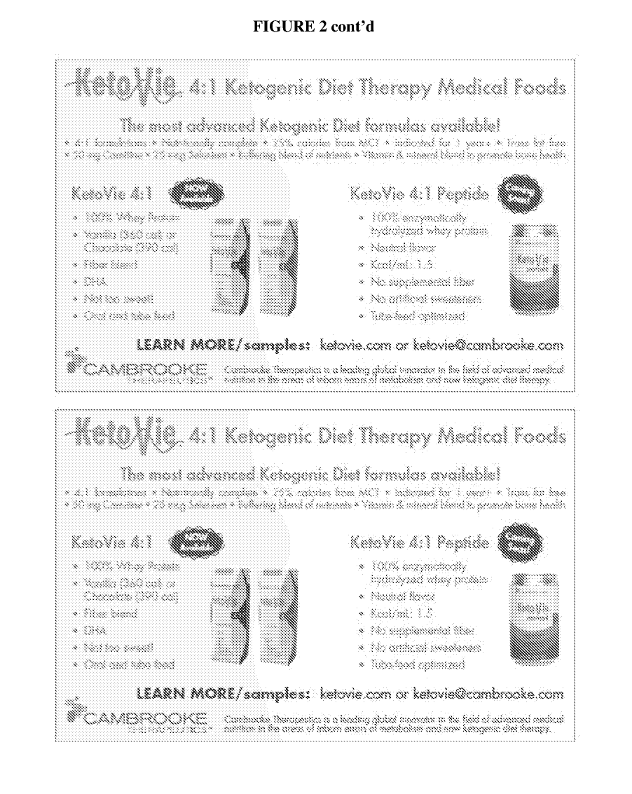

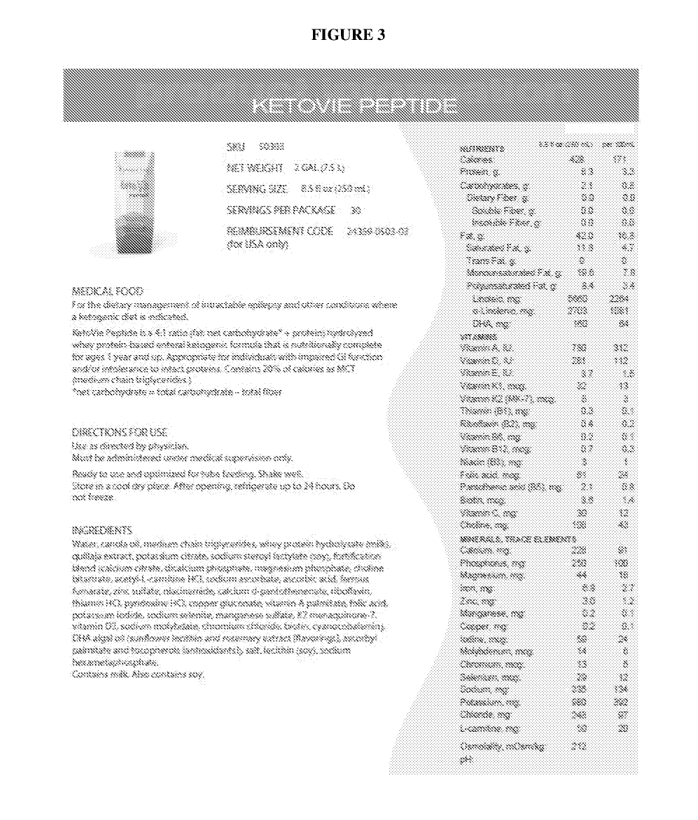

### DETAILED DESCRIPTION

Described herein is an aqueous ketogenic composition. A ketogenic nutritional formula can induce the state of ketosis (elevated levels of ketone bodies in the blood) in an individual, such as a human. Ketogenic compositions may be useful in the dietary management of certain medical conditions, such as intractable epilepsy, neurodegenerative disease (e.g., Alzheimer's disease), certain cancers (e.g., brain tumors and malignant glioblastomas), and diseases related to certain inborn errors of metabolism (e.g., glucose transporter syndrome and pyruvate dehydrogenase deficiency).

Described herein is an aqueous ketogenic composition, comprising: fat, hydrolyzed protein, and carbohydrate. An aqueous ketogenic composition can additionally further comprise at least one or more of the following: an emulsifier, vitamins and minerals. In the aqueous ketogenic composition, the ratio of fat grams to combined protein grams and net carbohydrate grams (grams of fat/grams of combined net carbohydrate and protein) is from 3:1 to 4:1; at least 10% of calories are from medium chain triglycerides (MCTs); and the potential renal acid load (PRAL) is negative. As used herein, the term “net carbohydrate” refers to total carbohydrate grams minus total dietary fiber grams. In some embodiments, the composition further comprises at least one antioxidant, a chelating agent and/or flavorings and sweeteners. In some embodiments, fat provides at least 86% of total calories in the formula. In some embodiments, fat comprises between about 10% and about 30% MCTs by calories and in a specific embodiment, the ketogenic composition contains about 20% of calories as MCTs. In some embodiments, fat comprises about 10% about 11%, about 12%, about 13%, about 14%, about 15%, about 16%, about 17%, about 18%, about 19%, about 20%, about 21% about 22%, about 23%, about 24% about 25%, about 26%, about 27%, about 28%,about 29%, or about 30% MCTs by calories. In some embodiments, fat comprises at least 15% MCTs by calories. In some embodiments, fat comprises at least 25% MCTs by calories. The chelating agent, such as sodium hexametaphosphate (SHMP), chelates minerals in the composition and helps reduce fat rancidity. The aqueous ketogenic composition described herein is useful, for example, in management of intractable epilepsy, neurodegenerative diseases or diseases related to certain inborn errors of metabolism.

Nutritional formulas having high osmolality shift water from the bloodstream to the gut and can cause osmotic diarrhea. The aqueous ketogenic compositions described herein address this problem. In some embodiments, the composition has an osmolality between about 200 mOsm/kg to about 350 mOsm/kg.

In some embodiments, the aqueous ketogenic composition described herein has a caloric density between about 0.8 kcal/mL and about 3 kcal/mL. In some embodiments, the aqueous ketogenic composition has a caloric density between about 1 kcal/mL and about 2 kcal/mL. In some embodiments, the aqueous ketogenic composition described herein has a caloric density of about 1.4 kcal per mL, about 1.5 kcal per mL, about 1.6 kcal per mL, about 1.7 kcal per mL, about 1.9 kcal per mL, or about 2.0 kcal per mL.

In some embodiments, the aqueous ketogenic composition described herein is nutritionally complete. As used herein, the term “nutritionally complete” refers to a composition having a complete nutritional profile of macro and micronutrients (e.g., containing carbohydrates, protein, fats, vitamins and minerals) for subjects 1 year of age and older. In some embodiments, the aqueous ketogenic composition provides the recommended daily intake (RDI), based on caloric needs for age, of macro- and micro-nutrients to a subject without reaching any upper limits (ULs) for any age group, when used as the sole source of nutrition for the subject. In some embodiments, the compositions described herein are nutritionally complete for subjects 1 year old and older.

One embodiment of an aqueous ketogenic composition is shown in the Table. In this embodiment, a liquid ketogenic formula comprises, per liter: between about 750 and about 900 mL water, between about 20 grams and about 60 grams hydrolyzed protein, between about 9 grams and about 240 grams fat, between about 0 grams (none added) and about 5 grams emulsifier, between about 0 grams (none added) and about 2 grams chelating agent, between about 0 (none added) grams and about 5 grams carbohydrate, between about 0 (non-nutritive, or none added) grams and about 2 grams sweetener, between about 0 grams and about 10 grams vitamins and minerals. In some embodiments, the composition comprises no supplemented dietary fiber.

In one embodiment, a liquid ketogenic formula comprises, per liter: between about 800 and about 850 mL water, between about 35 grams and about 45 grams hydrolyzed protein, between about 100 grams and about 150 grams fat, between about 1.5 grams and about 2.5 grams emulsifier, between about 0 grams (none added) and about 1 gram chelating agent, between about 2 grams and about 4 grams carbohydrate, between about 0 (non-nutritive, or none added) grams and about 0.5 grams sweetener, between about 4 grams and about 6 grams vitamins and minerals.

The aqueous ketogenic composition described herein may be administered by a variety of methods, such as by tube feeding or oral delivery. In some embodiments, the aqueous ketogenic composition is delivered by tube feeding. In some embodiments, the aqueous ketogenic composition is packaged in a carton, such as a Tetra Pak, and delivered orally. In some embodiments, the aqueous ketogenic composition is stored in a can, bottle or pouch. In some embodiments, the aqueous ketogenic composition is packaged in a can and sterilized by retort processing.

### Proteins

The aqueous ketogenic compositions as described herein comprise protein, which can be one type of protein or a combination of more than one type of protein. In some embodiments, the composition comprises whey protein. In some embodiments, the whey protein is whey protein isolate. In some embodiments, the protein is protein hydrolysate. The term “protein hydrolysate” refers to a solution of amino acids and short peptides prepared by degradation of a protein by acid, alkali or enzymatic digestion, in the presence of water. Generally, protein hydrolysates have reduced or low allergenicity compared to whole proteins because the small peptides (<1500 Daltons) comprising the hydrolysate are typically not antigenic. In some embodiments, at least 60% of protein hydrolysate is peptides having a molecular weight of less than between about 1000 Daltons and about 1500 Daltons. In some embodiments, at least 80% of protein hydrolysate is peptides having a molecular weight of less than 1500 Daltons. In some embodiments, at least 80% of protein is peptides having a molecular weight of less than 1500 Daltons. In some embodiments, at least 85% of the protein is peptides having a molecular weight of less than 1500 Daltons. In some embodiments, protein comprises free amino acids. In some embodiments, free amino acids comprise essential amino acids (e.g., histidine, isoleucine, leucine, lysine, methionine, phenylalanine, threonine, tryptophan, and/or valine). In some embodiments, free amino acids comprise non-essential amino acids (e.g., alanine, arginine, aspartic acid, cysteine, glutamic acid, glutamine, glycine, proline, serine, tyrosine, asparagine, and/or selenocysteine). In some embodiments, free amino acids comprise essential amino acids and non-essential amino acids. In some embodiments, protein is between about 2% and about 5% of the total weight of the composition

An adverse effect of some ketogenic formulas is ketoacidosis. In order to reduce the risk of acidosis, proteins generating lower amounts of acidic metabolites are utilized in the compositions described herein. Potential renal acid load (PRAL) is a method used to quantify the acidity of foods. A positive PRAL score indicates an acid forming food. A negative PRAL score indicates an alkaline-forming food. In some embodiments, the compositions described herein comprise a protein having a PRAL score less than or equal to zero. In some embodiments, the composition has a PRAL score that is less than or equal to zero. In some embodiments, the pH of the composition is between about pH 5.8 and about pH 6.8.

The protein may also affect the emulsion stability of the compositions described herein. In some embodiments, the aqueous ketogenic composition comprises protein that interacts with fat in the formula to form a stable emulsion.

### Fats

The majority of calories of the aqueous ketogenic composition are derived from fat. In some embodiments, fat provides between about 70% and about 99% of the calories contained in the aqueous ketogenic composition described herein. In some embodiments, fat provides at least 86% of the calories contained in the aqueous ketogenic composition. In some embodiments, fat provides at least 90% of the calories contained in the aqueous ketogenic composition. In some embodiments, fat provides at least 86%, at least 87%, at least 88%, at least 89% or at least 90% of the calories contained in the aqueous ketogenic composition. In some embodiments, fat is between about 10% and about 15% of the total weight of the composition.

The fat can be a single fat or multiple, different fats. The fat of the aqueous ketogenic compositions described herein may comprise saturated fats, unsaturated fats or a combination of saturated fats and unsaturated fats. Fat can comprise long chain fatty acids, short chain fatty acids or a combination of long chain fatty acids and short chain fatty acids. In some embodiments, fat comprises triglycerides, such as short-chain triglycerides, long-chain triglycerides, medium-chain triglycerides or a combination of two or three of the foregoing (e.g., short-chain triglycerides, long-chain triglycerides and medium-chain triglycerides; short-chain triglycerides and long-chain triglycerides; short-chain triglycerides and medium-chain triglycerides; medium-chain triglycerides and long-chain triglycerides). In some embodiments, fat comprises between about 1% and about 50% medium chain triglycerides. In some embodiments, fat comprises between about 10% and about 30% medium chain triglycerides. In some embodiments, fat comprises about 20%, about 21%, about 22%, about 23%, about 24%, about 25%, about 26%, about 27%, about 28%, about 29% or about 30% medium chain triglycerides. In some embodiments, the composition further comprises docosahexaenoic acid (DHA).

Examples of fat sources include but are not limited to: butter, animal fat (for example beef or chicken fat), vegetable oil (for example avocado, corn, and soybean), olive oil, canola oil, coconut oil, cocoa butter, fish oil, nuts (for example macadamia and peanut) and nut oils.

### Emulsifiers

Emulsifiers can be used to improve stability and texture of aqueous ketogenic compositions described herein. In some aspects, the aqueous ketogenic compositions comprise an emulsifier or emulsifying agent (e.g., a surfactant), such as sodium stearoyl lactylate (SSL), lecithin, starches, gums and biopolymeric emulsifiers. In some embodiments, the emulsifier is sodium stearoyl lactylate (SSL). In some embodiments, the emulsifier is a modified starch, such as octenyl succinate starch or other modified starch, that interferes with interaction of fat and protein in the formula, such as by binding of the octenyl moiety of the starch to fat globules. Without wishing to be bound by theory, binding of the modified starch to fat interferes (totally or partially) by steric hindrance with interaction of fat with proteins.

### Vitamins and Minerals

The aqueous ketogenic compositions described herein comprise vitamins and minerals. In some embodiments, the aqueous ketogenic composition comprises at least one vitamin selected from the group consisting of Vitamin A, Vitamin D3, Vitamin B 1, Vitamin B12, Vitamin B2, Vitamin B6, Vitamin K1, Vitamin K2, Vitamin B3, Vitamin B5, Biotin, Folic Acid, and at least one mineral selected from the group consisting of: Calcium, Chromium, Copper, Iodine, Iron, Manganese, Magnesium, Molybdenum, Phosphorus, Choline and Zinc. Sources of vitamins include: palmitates, beta-carotene, ergocalciferol, cholecalciferol, dl-alpha tocopheryl acetate, d-alpha tocopheryl acetate, dl-alpha tocotrienols, calcium panthothenate, pantothenol, pantothenic acid, cyanocobalamin, methylcobalamin, sodium ascorbate, calcium ascorbate, ascorbic acid, pyridoxine hydrochloride, pyridoxal 5′phosphate, riboflavin, thiamin, folic acid, phylloquinone, phytomenadione, phytonadione, menaquinones (e.g., MK-4 and MK-7) and biotin. Any combination of vitamins can be included in the aqueous ketogenic composition.

In some embodiments, the aqueous ketogenic composition comprises at least one mineral selected from the group consisting of: calcium, phosphorus, choline, magnesium, zinc, manganese, iron, copper, chromium, chloride, potassium, iodine, selenium, molybdenum and sodium. Sources of minerals include: calcium lactate, calcium gluconate, calcium pantothenate, calcium lactate gluconate, calcium phosphate, calcium carbonate, calcium citrate, calcium phosphate, magnesium phosphate, potassium phosphate, choline chloride, phosphatidylcholine, choline bitartrate, lecithin, magnesium chloride, magnesium oxide, magnesium gluconate, magnesium phosphate, magnesium malate, magnesium citrate, inositol hexanicotinate, nicotinamide, niacinamine, zinc carbonate, zinc citrate, zinc sulfate, zinc gluconate, zinc bisglycinate, manganese chloride, manganese gluconate, manganese sulfate, manganese picolinate, iron sulfate, iron citrate, iron gluconate, cupric oxide, copper gluconate, copper sulfate, copper carbonate, chromium picolinate, chromium chloride, chromium polynicotinate, chromium chloride, sodium chloride, potassium chloride, magnesium chloride, manganese chloride, choline chloride, potassium chloride, potassium citrate, potassium iodide, potassium sodium tartrate, potassium bisulfite, potassium iodide, sodium selenite, selenomethionine, sodium selenite, potassium molybdate, sodium molybdate, sodium chloride and sodium citrate. Any combination of minerals can be included in the aqueous ketogenic composition. In some embodiments, the aqueous ketogenic composition further comprises carnitine. Sources of carnitine include L-carnitine L-tartrate, L-carnitine citrate and L-carnitine acetate.

The addition of certain minerals, such as zinc, copper and/or iron, to food products is known to contribute to fat rancidity in food products. Chelation of sensitive minerals may therefore reduce fat rancidity by preventing minerals associated with fat rancidity from interacting with fats that are present in a composition. In some embodiments, the aqueous ketogenic compositions comprise a chelating agent, such as phosphates or phosphonates, EDTA and sodium hexametaphosphate (SHMP). In some embodiments, the chelating agent is sodium hexametaphosphate (SHMP). Other methods of reducing fat rancidity, such as the addition of antioxidants, are also known in the art. In some embodiments, the aqueous ketogenic composition described herein comprises at least one antioxidant, such as ascorbate, ascorbic acid (Vitamin C), cysteine and tocopherols.

### Carbohydrates

Aqueous ketogenic compositions comprise carbohydrate, such as starch, gum and/or fiber. In some embodiments, carbohydrate acts as a food stabilizer. In some embodiments, carbohydrate is less than about 1% of the total weight of the composition. In some embodiments, carbohydrate is a gum. In some embodiments, carbohydrate comprises carboxymethyl cellulose, carrageenan or carboxymethyl cellulose and carrageenan. In some embodiments, the composition does not contain supplemental dietary fiber. In some embodiments, the composition does not contain artificial or nutritive sweeteners.

In some embodiments, aqueous ketogenic compositions further comprise at least one sweetener, such as acesulfame potassium, sucralose, aspartame, lo han guo, stevia, erythritol, xylitol, maltitol, sorbitol, and other nutritive or non-nutritive sources.

### Preparation of Liquid Ketogenic Formulas

Aqueous ketogenic compositions can be produced by a variety of methods. In some embodiments, the aqueous ketogenic composition described herein is packaged in a can and sterilized by retort processing. As used herein, the term “retort processing” refers to a process utilizing pressure and heat to cook and seal food in a container. Retort processing generally involves the use of steam (e.g. water vapor) for sterilization. Examples of retort processes include saturated steam processes, water immersion processes, water spray processes and steam-air processes. Retort processing has a lower failure rate compared to aseptic processing with respect to sterilization. In some embodiments, the container is a pouch, bag, jar or bottle.

TABLE
One embodiment of a ketogenic aqueous composition comprising per liter:

| | Possible | |
|---|---|---|
| Component | Range | Unit |
| Water | 750-900 | mL |
| Protein hydrolysate | 20-60 | Grams |
| Medium chain triglyceride | 9-80 | Grams |
| Oil (from sources such as: nuts, seeds) | 9-240 | Grams |
| Emulsifier | 0-5 | Grams |
| Chelating Agent | 0-5 | Grams |
| Sweetener | 0-2 | Grams |
| Carbohydrates | 0-10 | Grams |
| Antioxidants | 1-5 | Grams |
| Vitamin and mineral blend | 0-10 | Grams |

We claim:

1. An aqueous ketogenic composition of low allergenicity, comprising:
fat, protein, carbohydrate, and, optionally, an emulsifier, vitamins and minerals, wherein the ratio of fat grams to combined protein and net carbohydrate grams is from 3:1 to 4:1; at least 10% of calories are from medium chain triglycerides (MCTs); at least 80% of the protein is peptides of molecular weight less than about 1500 Daltons; and the potential renal acid load (PRAL) is less than or equal to zero.

2. An aqueous ketogenic composition of low allergenicity, comprising:
fat, protein, and carbohydrate, wherein the ratio of fat to combined protein and net carbohydrate is from 3:1 to 4:1; at least 10% of calories are from medium chain triglycerides (MCTs); at least 80% of the protein is peptides of molecular weight less than about 1500 Daltons; and the potential renal acid load (PRAL) is less than or equal to zero.

3. The composition of claim 1, wherein the caloric density is between about 1.4 and about 1.5 kcal per mL.

4. The composition of claims 1 to 3, wherein the composition is nutritionally complete.

5. The composition of any one of claims 1 to 4, wherein the pH of the composition is between about pH 5.8 and about pH 6.8.

6. The composition of any one of claims 1 to 5, wherein the composition has an osmolality between about 200 mOsm/kg to about 350 mOsm/kg.

7. The composition of any one of claims 1 to 6, wherein fat provides at least 86% of the calories in the composition.

8. The composition of any one of claims 1 to 7, wherein fat is between about 10% and about 15% of the total weight of the composition.

9. The composition of any one of claims 1 to 8, further comprising DHA.

10. The composition of any one of claims 1 to 9, wherein fat provides at least the recommended daily intake (RDI) of linoleic and/or alpha linolenic acid for children 8 years and younger.

11. The composition of any one of claims 1 to 10, wherein protein is between about 2% and about 5% of the total weight of the composition.

12. The composition of any one of claims 1 to 11, wherein the protein has low allergenicity.

13. The composition of any one of claims 1 to 12, wherein protein is whey protein isolate.

14. The composition of any one of claims 1 to 13, wherein protein comprises protein hydrolysate.

15. The composition of any one of claims 1 to 14, wherein at least 80% of protein hydrolysate is peptides having a molecular weight of less than 1500 Daltons.

16. The composition of claim 15, wherein at least 80% of protein is peptides having a molecular weight of less than 1500 Daltons.

17. The composition of claim 16, wherein at least 85% of protein is peptides having a molecular weight of less than 1500 Daltons.

18. The composition of any one of claims 1 to 17, wherein carbohydrate is less than about 1% of the total weight of the composition.

19. The composition of any one of claims 1 to 18, wherein carbohydrate comprises a gum.

20. The composition of any one of claims 1 to 19, wherein carbohydrate comprises carboxymethyl cellulose, carrageenan or carboxymethyl cellulose and carrageenan.

21. The composition of any one of claims 1 to 20, wherein the composition does not contain supplemental dietary fiber.

22. The composition of any one of claims 1 to 21, wherein the composition does not contain artificial or nutritive sweeteners.

23. The composition of any one of claims 1 to 22, wherein the emulsifier is selected from the group consisting of sodium stearoyl lactylate.

24. The composition of any one of claims 1 to 23, further comprising a chelating agent.

25. The composition of claim 24, wherein the chelating agent is sodium hexametaphosphate (SHMP).

26. The composition of any one of claims 1 to 25, further comprising carnitine, selenium, or carnitine and selenium.

27. The composition of any one of claims 1 to 26, wherein carnitine is present at a concentration between about 20 mg to about 80 mg per 100 mL composition.

28. The composition of any one of claims 1 to 27, wherein selenium is present at a concentration between about 10 μg to about 30 μg per 1000 mL.

29. The composition of any one of claims 1 to 28, further comprising at least one antioxidant.

30. The composition of any one of claims 1 to 29, wherein the vitamins include at least one vitamin selected from the group consisting of: Vitamin A, Vitamin D3, Vitamin B 1, Vitamin B12, Vitamin B2, Vitamin B6, Vitamin K1, Vitamin K2, Vitamin B3, Vitamin B5, Biotin, Folic Acid, and the minerals include at least one mineral selected from the group consisting of: Calcium, Chromium, Copper, Iodine, Iron, Manganese, Magnesium, Molybdenum, Phosphorus, Choline and Zinc.

31. The composition of any one of claims 1 to 30, wherein less than about 1% of the total weight of the composition is vitamins and minerals.

32. The composition of any one of claims 1 to 31, wherein the composition is in a container and sterilized by retort processing.

33. An aqueous ketogenic composition of claim 1 or claim 2, in which about 20% of calories are from medium chain triglycerides (MCTs).

34. An aqueous ketogenic composition of any one of claims 1, 2 and 33, in which the caloric density is about 1.7 kcal per mL
